(19) United States
(12) Patent Application Publication
(10) Pub. No.: US 2005/0063579 A1
(43) Pub. Date: Mar. 24, 2005

(54) Method of automatically detecting pulmonary nodules from multi-slice computed tomographic images and recording medium in which the method is recorded

(76) Inventors: Jeong Won Lee, Daejeon-city (KR); Seunghwan Kim, Daejeon-city (KR); Youn Tae Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/873,877

(22) Filed: Jun. 22, 2004

(30) Foreign Application Priority Data
Sep. 18, 2003 (KR) 2003-64722

(51) Int. Cl. G06K 9/00; G06K 9/46

(52) U.S. Cl. 382/131; 382/195

(57) ABSTRACT

A method of automatically detecting pulmonary nodules is provided, including the operations of acquiring a chest computed tomography (CT) image, extracting a lung region from the chest CT image, extracting a group of nodule candidates from the lung region using a gray-level thresholding technique and a three-dimensional (3-D) region growing technique, and performing 3-D feature recursive analysis on all of the nodule candidates.

### BACKGROUND OF THE INVENTION

This application claims the benefit of Korean Patent Application No. 2003-64722, filed on Sep. 18, 2003, in the Korean Intellectual Property Office, the disclosure of which is incorporated herein in its entirety by reference.

1. Field of the Invention

The present invention relates to a method of automatically detecting pulmonary nodules from a chest computed tomographic (CT) image, and more particularly, to a method of automatically detecting pulmonary nodules using three-dimensional feature-analysis techniques and a computer readable recording medium which stores a program for executing the method.

2. Description of the Related Art

Pulmonary masses or pulmonary nodules are represented as circular shades enclosed by distinctive boundaries on chest radiographs. Shades with diameters of 30 mm or less are classified as pulmonary nodules, and shades with diameters of more than 30 mm are classified as pulmonary masses. A single circular or oval lesion not accompanied with atelectasis or pneumonia is called as a solitary pulmonary nodule. 70% of a lung cancer is the solitary pulmonary nodule. Since the lung cancer is a leading cause of cancer death, detection of nodules at an early stage is the most important thing. In other words, since approximately 90% of the pulmonary nodules included in a lung cancer can be cut off, early detection of the pulmonary nodules may increase the survival rate.

Theoretically, it is preferable to find a disease at a stage where the disease can be controlled or cured without symptoms. If a disease is found at an early stage through screening, an inspection for definite diagnosis can be performed, and natural disease development can be stopped. However, if a lung caner is detected from simple chest radiographs through screening, it has already been seriously developed so that the five-year survival rate cannot be increased. Hence, a CT examination has been introduced and produces too much image data for physicians to interpret. This interpretation of much image data is a time-consuming task for radiologists, so pulmonary nodules may be missed in CT images. Especially, an incipient cancer may be easily missed because it appears as a small nodule with a diameter of 3 mm or less. Accordingly, a lung cancer interpretation is based on a double check by two physicians. If results of automatic detection of pulmonary nodules using a computer-aided diagnosis (CAD) program are used as a reference opinion, the interpretation accuracy may be increased.

Up to now, a CAD program for detecting pulmonary nodules from CT images is not yet common. The CAD program is being actively studied by the University of Chicago. ‘ImageChecker CT LN-1000’ manufactured by R2 Technology Inc. based on results of a study by the University of Chicago has been approved by Food & Drug Administration (FDA) of U.S.A on June, 2003. The product ‘ImageChecker CT LN-1000’ is being sold in the U.S.A to be used for clinical experiments. Nothing but the product ‘ImageChecker CT LN-1000’ has been commercialized, and many countries are under development of the CAD program for pulmonary nodule auto-detection.

Two approaches of a model-based analysis technique and a rule-based analysis technique have been developed. The model-based analysis technique uses a spherical model having the same shape as a nodule. In the rule-based analysis technique, nodule candidates are extracted, and abnormal nodules are distinguished from normal anatomy (such as blood vessels) based on a priori knowledge. Since the range of brightness values of a nodule on a CT image is wide, the rule-based analysis technique usually uses a multiple gray-level thresholding.

### SUMMARY OF THE INVENTION

The present invention provides a method of automatically detecting accurate pulmonary nodules included in a lung region from chest CT images.

The present invention also provides a computer readable recording medium which stores a computer aided diagnosis (CAD) program for executing the method.

According to an aspect of the present invention, there is provided a method of automatically detecting pulmonary nodules. In this method, first, a chest computed tomography (CT) image is acquired, and a lung region, which is a region of interest, is extracted from the chest CT image. Then, three-dimensional (3-D) data is obtained from the internal image of the lung region, and a group of nodule candidates is extracted from the lung region 3-D data using a gray-level thresholding technique and a 3-D region growing technique. Thereafter, 3-D feature calculation and analysis are recursively performed on all of the nodule candidates. As a recursive analysis operation proceeds, each of the nodule candidates is divided into smaller nodule candidates using a nodule isolation technique based on a radial distribution function and a technique of re-extracting the nodule candidates so that the nodule candidates can establish a tree structure by increasing a gray level threshold. The recursive analysis operation is repeated until each of the nodule candidates is determined to be one of a pulmonary nodule and a non-pulmonary-nodule or until a volume of the nodule candidate becomes too small to mean a nodule. Particularly, a parameter extracted from a relationship between nodule candidates that form parent and child nodes in the tree structure is used as a 3-D feature, thereby increasing the accuracy of pulmonary nodule detection.

In the detection method, nodule candidate groups are extracted from the lung region such as to form a tree structure, and the nodule candidate groups are recursively analyzed using 3-D feature values to detect a pulmonary nodule. This technique, which is a feature of the present invention, is referred to as a 3D recursive analysis (3DRA) technique. The 3DRA technique is an improvement on an existing multi-gray level thresholding technique corresponding to simple extraction of nodule candidates and feature values in that parameters extracted from a relationship between nodule candidates that form parent and child nodes in the tree structure are used in a pulmonary nodule analysis operation.

The nodule isolation technique based on a radial distribution function (which is referred to as NIRD) can solve a problem of improper extraction of features of a nodule attached to a blood vessel because of the blood vessel. Also, NIRD has an advantage in that accurate 3D feature analysis can be achieved because analysis is made on a single nodule from which not only a blood vessel but also a normal anatomical structure or another nodule is removed.

According to another aspect of the present invention, there is provided a computer readable recording medium which stores a program, the program including: a first program module obtaining a chest CT image; a second program module extracting a lung region from the CT image; a third program module extracting a nodule candidate group from the lung region using a gray-level thresholding technique and a 3-D region growing technique; a fourth program module separating a nodule candidate into a core portion and a tail portion using a nodule isolation technique based on a radial distribution function; a fifth program module implementing a rule-based system which analyses 3-D features of the nodule candidate to determine whether the nodule candidate is a pulmonary nodule; and a sixth program module recursively performing the third, fourth, and fifth program modules.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a hardware system to which the present invention is applied;

FIG. 2 is a schematic flowchart illustrating a method of automatically detecting pulmonary nodules from chest computed tomographic (CT) images, according to an embodiment of the present invention;

FIG. 3 illustrates a chest CT image including pulmonary nodules, which is used as an input value in the method of FIG. 2;

FIG. 4 illustrates a lung region, which is a region of interest, extracted from a chest CT image according to the method of FIG. 2;

FIG. 5 is a view illustrating a lung contour correcting operation included in the method of FIG. 2;

FIG. 6 illustrates CT images to illustrate a result of the lung contour correcting operation;

FIG. 7 is a detailed flowchart focused on illustrating a three-dimensional feature recursive analysis included in the method of FIG. 2;

FIG. 8 illustrates a tree structure in which nodule candidates are arranged;

FIG. 9 is a view illustrating a method of obtaining a deepness of each point in a nodule candidate;

FIG. 10A illustrates a spherical nodule candidate;

FIG. 10B is a view illustrating a method of obtaining a radial distribution function for the spherical nodule candidate of FIG. 10A;

FIG. 11 is a graph showing a radial distribution function of the spherical nodule candidate of FIG. 10A;

FIG. 12A illustrates a nodule candidate in which a blood vessel is attached to a spherical pulmonary nodule;

FIG. 12B is a view illustrating a method of obtaining a radial distribution function for the nodule candidate of FIG. 12A; and

FIG. 13 is a graph showing a radial distribution function of the nodule candidate of FIG. 12A.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the forms of elements are exaggerated for clarity. To facilitate understanding, identical reference numerals have been used, where possible, to designate identical elements that are common to the figures.

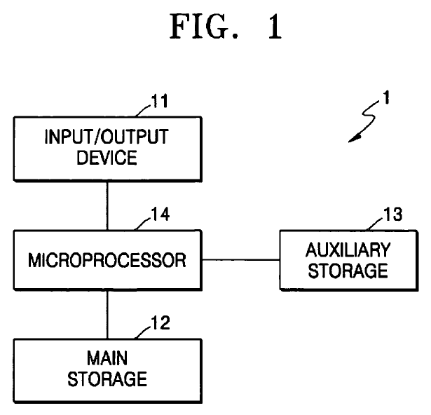

FIG. 1 is a block diagram of a hardware system 1 to which the present invention is applied. Referring to FIG. 1, the hardware system 1 includes an input/output device 11, main and auxiliary storages 12 and 13, and a microprocessor 14. The input/output device 11 is used by an external user to input/output chest computed tomography (CT) image data required upon pulmonary nodule detection. The main and auxiliary storages 12 and 13 store various types of data required to detect pulmonary nodules from chest CT images. The microprocessor 14 controls the main and auxiliary storages 12 and 13 and the input/output device 11 and performs all arithmetic operations required to detect pulmonary nodules from chest CT images.

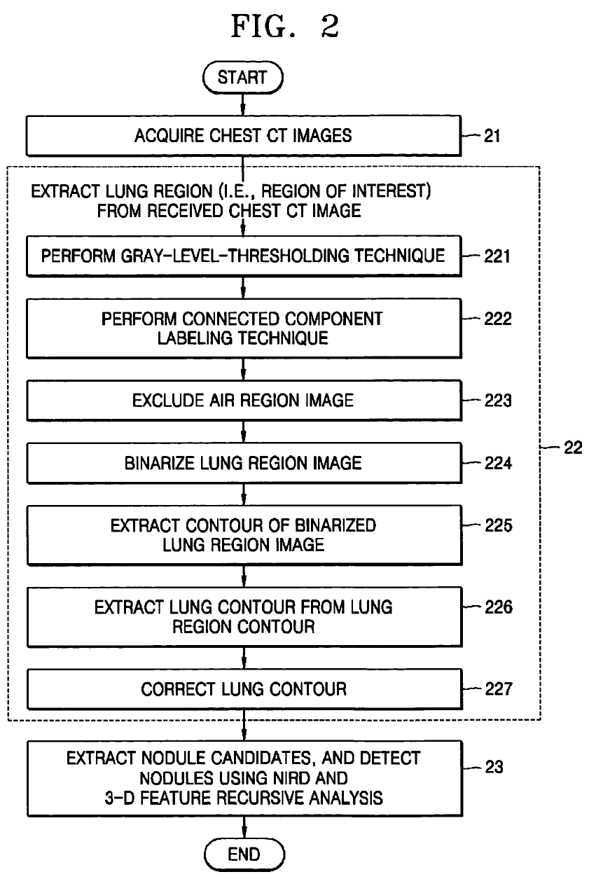

A pulmonary nodule auto-detection method using chest CT images, according to the present invention, is performed using the hardware system 1. A computer aided diagnosis (CAD) program including a method of FIG. 2 to be described later is installed in the microprocessor 14. When the microprocessor 14 receives chest CT images and executes the CAD program, pulmonary nodules are automatically detected from the chest CT images.

FIG. 2 is a schematic flowchart illustrating a method of automatically detecting lung nodules from chest CT images, according to an embodiment of the present invention. Referring to FIG. 2, first, a CT image of the chest of a person having pulmonary nodules is acquired and received, in operation 21. As an image slice becomes thinner, and a reconstruction interval becomes narrower, the resolution of a chest CT image increases. For example, a multi-slice CT image with an approximately 2 mm slice and an about 1 mm reconstruction interval may be obtained. The CT image is immediately digitized in photographing equipment and stored and transmitted in a medical image standard file format, which is called a digital imaging and communications in medicine (DICOM). A DICOM-format CT image file is composed of 512×512 pixels, each of which is represented in 4096 gray levels with 12-bit depths. Since the header of the DICOM format image file includes patient information and information about photographing conditions, the header can be used to calculate feature values upon image analysis. Examples of the photographing condition information include a slice thickness, a reconstruction interval, and the like. Examples of the patient information includes the age of a patient, and the like.

Then, in operation 22, a lung region, which is a region of interest, is extracted from the received chest CT image. The lung region extraction operation 22 includes seven sub-operations, which are operation 221 of binarizing the chest CT image using a gray-level-thresholding, operation 222 of labeling a lung region image and a air region image from the binarized image using a connected component labeling technique, operation 223 of excluding the air region image, operation 224 of binarizing the lung region image, operation 225 of extracting a contour of the binarized lung region image using an edge detection technique, operation 226 of extracting only a lung contour from the extracted lung region contour; and operation 227 of correcting the lung contour.

Thereafter, in operation 23, nodule candidates are extracted from three-dimensional (3-D) data reconstructed using extracted lung region images, and nodule detection is performed using Nodule Isolation using Radial Distribution (NIRD) and 3-D feature Recursive Analysis (3DRA).

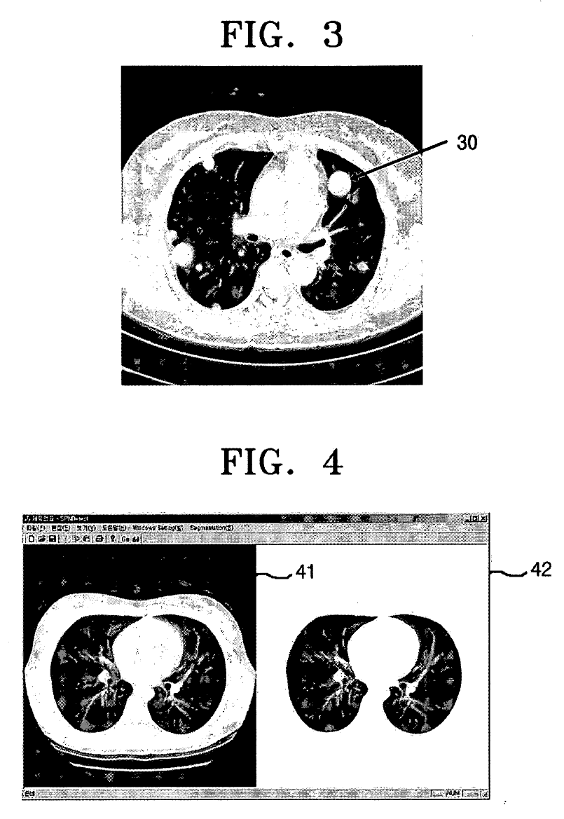

FIG. 3 illustrates a chest CT image of a patient having pulmonary nodules, which is used as an input value in the operation 21 of FIG. 2. Pixels of the X-ray CT image are each composed of gray level values obtained by reconstructing values associated with X ray amounts absorbed by the body of the patient. The amount of X-ray absorbed by the body depends on the densities, thicknesses, and the like of a bone and a soft tissue. A bright and circular portion 30 denotes a pulmonary nodule lesion.

FIG. 4 illustrates a lung region extracted from a chest CT image in the operation 22 of FIG. 2. Reference numeral 41 denotes an original chest CT image (i.e., the state of the CT image of FIG. 3), and reference numeral 42 denotes an image having only a lung region extracted from the original chest CT image 41 in the operation 22 of FIG. 2. Since organs displayed on a CT image have different X-ray attenuation rates depending on tissue characteristics, each of the organs has a specific range of gray level values. Gray level values of a CT image are expressed in Hounsfield Units (HU). The CT image normally has gray levels of −1024 to +3072 HU. Since the lung is filled with air, the lung region has a HU value lower than the soft tissue at the contour of the lung and other organs. When operation 223 is performed after gray-level-thresholding operation 221 and connected component labeling operation 222, the lung region is separated from the region outside the lung region. However, since the lung region includes pulmonary nodules, blood vessels, and general organs (such as a part of a lung wall), which have high gray-level values, the contours of the pulmonary nodules, blood vessels, and general organs can be removed by undergoing binarization operation 224, binarized image contour extraction operation 225, and lung contour extraction operation 226. However, the contour of the remained lung region still does not include blood vessels and nodules existing at the lung wall. Hence, lung contour correction operation 227 is preferably, but not necessarily, used to solve the problem in that the blood vessels and nodules existing at the lung wall cannot be identified.

In lung contour correction operation 227, rough parts of the lung wall from the extracted lung contour are corrected so that the nodules, vessels, and general organs on the lung wall can be included in the lung region. First, outwardly convex points of the points on the lung contour are obtained by calculating a feature “convexity”. The convexity of each of the points on the lung contour on a two-dimensional (2-D) image is calculated. In the calculation of the convexity of a point on a lung contour, if a triangle formed by the point of interest and two adjacent points existing 5 points apart from the point has a vertex lying outside the lung region, the point of interest is determined to be convex. If the vertex of the triangle lies inside the lung region, the point of interest is determined to be concave.

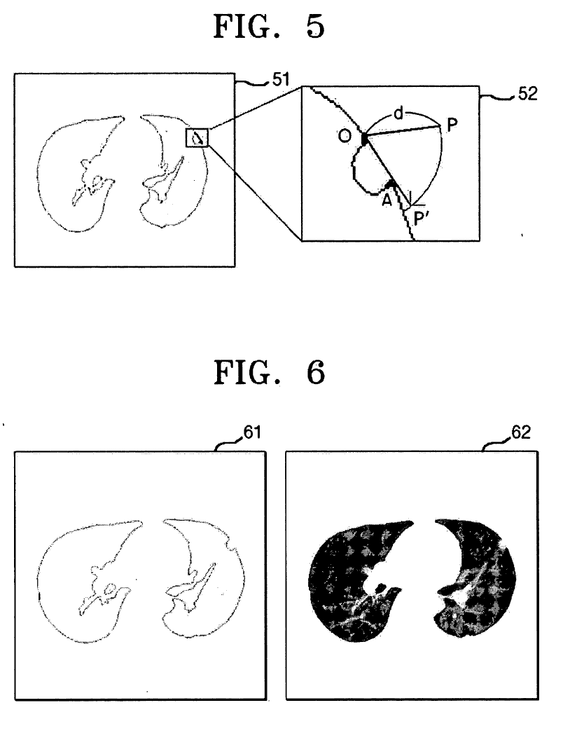

FIG. 5 illustrates a CT image to explain lung contour correcting operation 227. Reference numeral 51 denotes an image including a lung contour to be corrected, and reference numeral 52 denotes a magnification of a part of the image 51. Lung contour correcting operation 227 is equally applied to all of the convex points on the lung contour. More specifically, if a convex point on the lung contour is indicated by O as illustrated in FIG. 5, a line segment OP having a length of “d” starting from the convex point O lies in a normal line direction. The line segment OP descends clockwise or counterclockwise until it meets another point on the lung contour, so a new lung contour including the area between the lowered line segment OP and the extracted lung contour is obtained. In FIG. 5, while the line segment OP is descending clockwise, a descending line segment OP meets a point A, and thus a line segment OA forms a new lung contour. By using such a lung contour correcting operation, nodules and blood vessels in contact with the lung wall can be included in the lung region. Preferably, when a costal pleural contour of the lung is corrected, the value “d” denotes 40 pixels. When a mediastinal pleural contour of the lung is corrected, the value “d” denotes 30 pixels.

FIG. 6 illustrates CT images to illustrate a result of the lung contour correcting operation. Reference numeral 61 denotes a chest CT image displaying a lung contour which is not yet corrected, and reference numeral 62 denotes a chest CT image displaying a lung region whose contour has been corrected according to the lung contour correction operation 227.

Referring back to FIG. 2, after a lung region is extracted in operation 22, nodule candidates are extracted from the lung region in operation 23. The lung region extraction operation is performed on a 2-D cross-sectional image, but the nodule candidate extraction operation and its subsequent operations are performed on 3-D data reconstructed from a lung region image. Although 3-D analysis requires a large memory, its execution time is less than 2-D analysis, and 3-D features can be analyzed. 3-D image data is reconstructed using a 2-D cross-sectional image. If a point on a 2-D image is referred to as a pixel, a point in a 3-D image is referred to as a voxel.

Because each organ in a CT image of a human body has a specific range of a HU values as described above, nodule candidates can be extracted based on an appropriate threshold. The nodule candidates may include blood vessels and/or normal anatomical structures in addition to nodules. Upon extraction of nodule candidates, when a point having a specific gray level threshold or greater is first found during 3-D image data scan, the point is set to be a seed, and a 3-D region growing technique is preferably performed.

The nodule candidates extracted according to the 3-D region growing technique are each labeled using the connected component labeling technique. The nodule candidates are classified into nodules, blood vessels, or normal anatomical structures by calculating and analyzing the 3-D features of each of the nodule candidates. Examples of the 3-D features analyzed include a volume, a compactness, an elongation factor, and the like, and maximum, minimum, and mean HU values can also be analyzed. Particularly, a parameter extracted from nodule candidates that establish a parent-child node relationship in a tree structure is also used as a 3-D feature. For example, a volume ratio, which is obtained by dividing the volume of a child node candidate by the volume of a parent node candidate, is referenced together with the volume, the compactness, the elongation factor, and the HU value to determine whether a nodule candidate is a nodule. Calculated 3-D features are all input to a rule-based system which identifies pulmonary nodules. The volume of a nodule candidate is obtained by converting the number of voxels that form the nodule candidate into a value of mm³. The compactness denotes a degree by which the geometrical shape of a nodule is close to a sphere. In other words, the compactness is defined as the fraction of the volume of a nodule candidate to the volume of a sphere circumscribed about the nodule candidate. The elongation factor also denotes a degree by which the geometrical shape of a nodule is close to a sphere. In other words, the elongation factor is defined as the fraction of a long axis of a nodule candidate to a short axis of the nodule candidate. The volume fraction (i.e., the volume ratio) will be described in greater detail later.

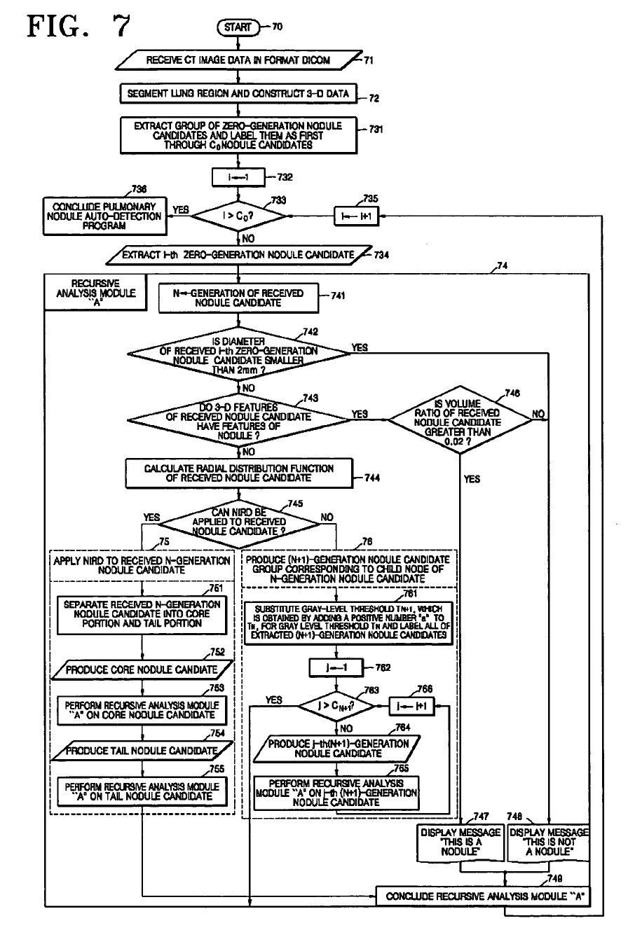

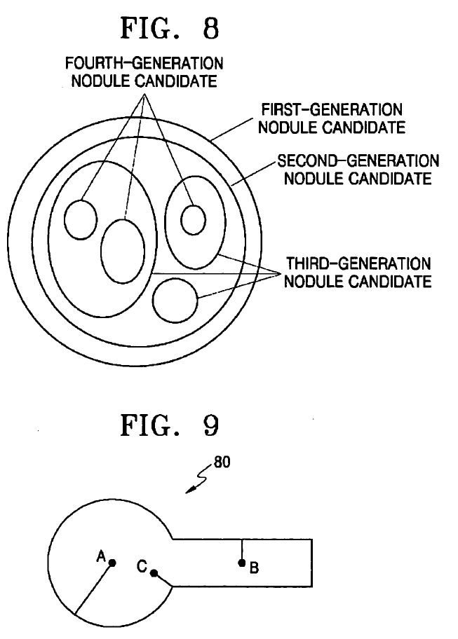

FIG. 7 is a detailed flowchart focused on illustrating recursive NIRD analysis and 3-D feature recursive analysis of nodule candidates in a pulmonary nodule auto-detection method according to an embodiment of the present invention. FIG. 8 illustrates a tree structure in which nodule candidates are arranged.

Referring to FIGS. 7 and 8, in operation 71, CT image data is received. In operation 72, a lung region is segmented, and an image of the lung region is converted into 3-D data. In operation 731, zero-generation nodule candidates, which are on the top level in the tree structure, are extracted and labeled. The nodule candidate extraction is achieved using the 3-D region growing technique. A gray-level threshold used to set a seed point for an N-generation nodule candidate is referred to as T_{N}. When a seed point is set, the 3-D region growing technique is performed to register points having higher brightness values than the gray-level threshold T_{N} in a single N-generation nodule candidate. When the 3-D region growing technique with respect to a seed point is completed, a next seed point is searched for. Points having brightness values higher than a gray-level threshold T_{N}, among points not yet registered as a nodule candidate, are set as new seed points. As described above, there may exist more than one seed point that exceed the gray-level threshold T_{N}, and the seed points individually undergo the 3-D region growing technique and are registered as more than one N-generation nodule candidate. The N-generation nodule candidates are labeled using the connected component labeling technique. For example, if C_{N} N-generation nodule candidates are registered, they are labeled first through C_{N}-th nodule candidates.

In operation 74, a recursive analysis module A is performed on each of first through C₀ zero-generation nodule candidates. If all of the first through C₀ zero-generation nodule candidates are completely analyzed, the pulmonary nodule auto-detection method is concluded, in operation 736. Before the recursive analysis module A is performed in operation 74, a single nodule candidate, for example, an i-th zero-generation nodule candidate, is received, in operation 734. In operation 742, it is determined whether the diameter of the received i-th zero-generation nodule candidate is smaller than 2 mm. If the diameter is smaller than 2 mm, the received nodule candidate is considered as noise, and a message “this is not a nodule” is displayed, in operation 748. Thereafter, the method is concluded, in operation 749. If it is determined in operation 742 that the received nodule candidate has a diameter of 2 mm or greater, it is determined whether 3-D features of the received nodule candidate are the same as those of a nodule, in operation 743. If it is determined in operation 743 that the received nodule candidate has the features of a nodule, it is determined whether the volume ratio of the received nodule candidate (where the volume ratio denotes a volume ratio of an N-generation nodule candidate to an (N-1)-generation nodule candidate, which is a parent nodule candidate of the N-generation nodule candidate) is greater than 0.02, in operation 746. If the volume ratio is greater than 0.02, the received nodule candidate is determined to be a nodule, and a message “this is a nodule” is displayed, in operation 747. Thereafter, the recursive analysis module A is concluded, in operation 749. On the other hand, if the volume ratio is smaller than or equal to 0.02, the received nodule candidate is determined to be a false positive of a vessel or a normal anatomical structure, and the message “this is not a nodule” is displayed, in operation 748. Thereafter, the recursive analysis module A is concluded, in operation 749. If the recursive analysis module A for the i-th zero-generation nodule candidate is concluded, the value of i is increased by 1, in operation 735. If it is determined in operation 733 that the value of i+1 is equal to or smaller than C₀, an (i+1)th zero-generation nodule candidate is received, in operation 734. If the recursive analysis module A for the N-generation nodule candidate other than a zero-generation nodule candidate is completed, the method returns to the operation in which the recursive analysis module A has been called.

If it is determined in operation 743 that 3-D features of an N-generation nodule candidate received to undergo the recursive analysis module A are not the features of a nodule, a radial distribution function of the received nodule candidate is obtained, in operation 744. Then, in operation 745, the radial distribution function of the received nodule candidate is analyzed to check if received nodule candidate can be separated into a core portion and a tail portion. This analysis corresponds to an analysis to check if NIRD can be applied. In NIRD, a core portion (i.e., a nodule) of a nodule candidate is separated from a tail portion (i.e., a vessel, a normal anatomical structure, or other nodules attached to the nodule candidate), which serves as noise upon 3-D feature analysis, so that 3-D features of only the core portion can be analyzed. Thus, 3-D feature analysis results are reliable, and the sensitivity of nodule detection is increased. If it is determined from the radial distribution function analysis in operation 745 that NIRD can be applied, the received N-generation nodule candidate is separated into a core portion and a tail portion, in operation 751. Then, in operations 752 and 753, a core N-generation nodule candidate undergoes a recursive analysis module A. After the recursive analysis module A on the core N-generation nodule candidate is completed, a tail N-generation nodule candidate undergoes a recursive analysis module A, in operations 754 and 755. The core N-generation nodule candidate replaces the N-generation nodule candidate, and the tail N-generation nodule candidate is registered as a new N-generation nodule candidate. Nodule isolation using a radial distribution function analysis (that is, NIRD) will be described later in greater detail with reference to FIGS. 9 through 13.

If it is determined in operation 745 that the N-generation nodule candidate cannot be separated using NIRD, a group of (N+1)-generation nodule candidate corresponding to a child node of the N-generation nodule candidate are extracted, in operation 76. In operation 761, the gray level threshold T_{N} to be used in the 3-D region growing technique is substituted by a gray-level threshold T_{N+1}, which is obtained by adding a positive number “a” to T_{N}. The number “a” may be a 50 HU. When a seed point is extracted using the gray-level threshold T_{N+1}, which is greater than the gray level threshold T_{N}, and the 3-D region growing technique is applied to the seed point to extract a group of (N+1)-generation nodule candidates using the same way as the way used to extract the N-generation nodule candidate, one or more (N+1)-generation nodule candidates can be extracted. Also, in operation 761, all of the (N+1)-generation nodule candidates are labeled using the connected component labeling technique as in the labeling of the N-generation nodule candidate. If the number of (N+1)-generation nodule candidates, which are child candidates of a single N-generation nodule candidate, is C_{N+1}, they are labeled as first through C_{N+1} (N+1)-generation nodule candidates. The N-generation nodule candidate and the (N+1)-generation nodule candidates are arranged in a tree structure as shown in FIG. 8 such that the (N+1)-generation nodule candidates become child candidates of the N-generation nodule candidate. Then, in operations 764 and 765, the C_{N+1} (N+1)-generation nodule candidates are sequentially received, and each undergoes the recursive analysis module A. If all of the C_{N+}1 (N+1)-generation nodule candidates complete undergoing the recursive analysis module A, the method returns to the operation in which the recursive analysis module A for the N-generation nodule candidate has been called.

As described in operation 746, a volume ratio, which is a 3-D feature of a nodule candidate, is a value obtained by dividing the volume of a N-generation nodule candidate (a child node) by the volume of a (N−1)-generation nodule candidate (a parent node). The volume ratio plays an important role in reducing the number of false positive decisions. The volume ratio of a nodule candidate still including a part of a vessel is usually greatly small, so a nodule candidate having a volume ratio of less than 0.02 is determined as a non-nodule. In other words, the tree structure of nodule candidate groups does not mean only a data structure but is also used as an important basis to decide whether a nodule candidate extracted from the tree structure is a nodule.

Particularly, an NIRD algorithm is used in a pulmonary nodule auto-detection method according to the present invention. Hence, such an NIRD operation as operation 75 is performed for the purpose of solving the problem in that features of a nodule overlapped by a vessel may not be properly extracted by the existence of the vessel. In other words, in the NIRD operation, the vessel is separated from the nodule, so 3-D features of the nodule can be accurately analyzed. More specifically, not only a vessel attached to a nodule but also a normal anatomical structure or other nodules attached to the nodule is detached from the nodule so that 3-D feature analysis can be performed on a single nodule.

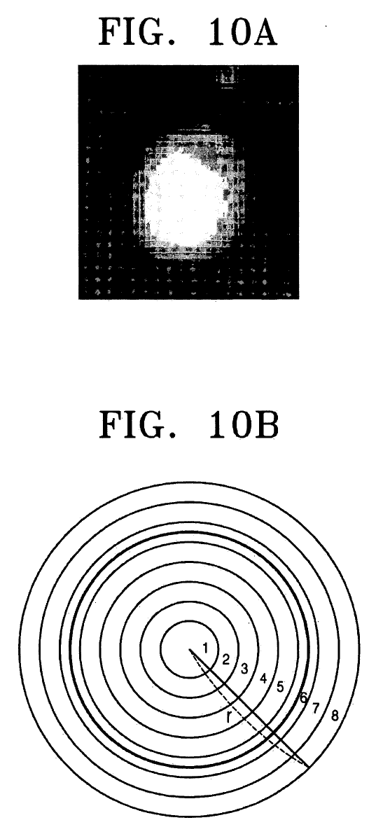

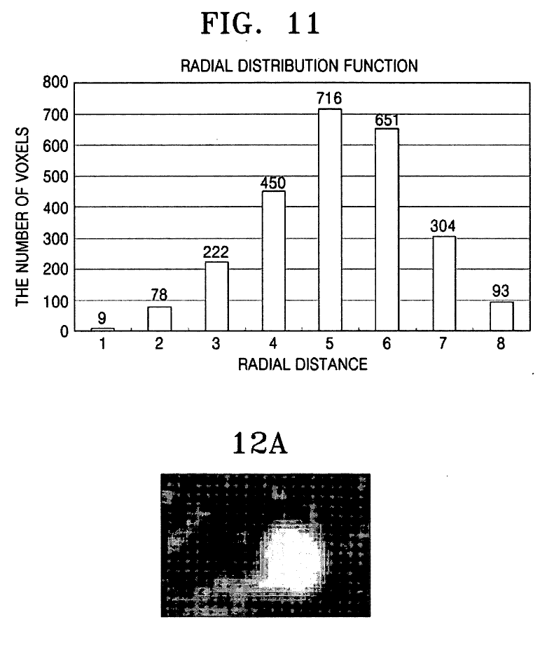

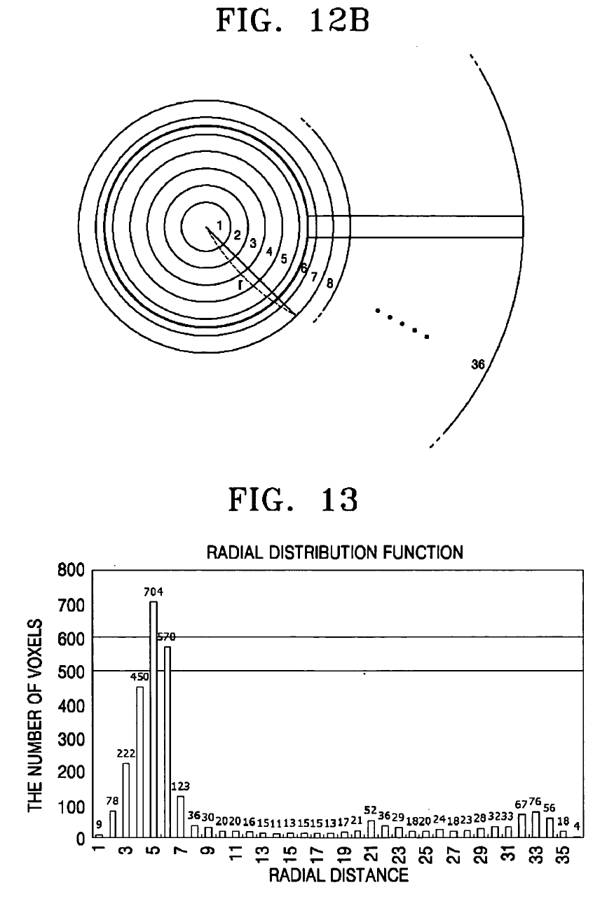

FIGS. 9 through 13 are used to describe the NIRD operation. FIG. 9 is a view illustrating a method of obtaining deepness parameters of points A, B, and C in a nodule candidate in which a vessel is attached to a nodule. FIG. 10A illustrates a spherical nodule candidate. FIG. 10B is a view illustrating a method of obtaining a radial distribution function for the spherical nodule candidate of FIG. 10A. FIG. 11 is a graph showing a radial distribution function of the spherical nodule candidate of FIG. 10A. FIG. 12A illustrates a nodule candidate in which a blood vessel is attached to a spherical nodule. FIG. 12B is a view illustrating a method of obtaining a radial distribution function for the nodule candidate of FIG. 12A. FIG. 13 is a graph showing a radial distribution function of the nodule candidate of FIG. 12A. The peaks in FIGS. 11 and 13 are located at a radial distance of about 5.5 and indicated by bold circles in FIGS. 10B and 12B, respectively. Regions enclosed by the bold circles are nodules.

In the calculation of a radial distribution function of nodule candidates, first, the deepness of each of voxels of the nodule candidates is calculated. The deepness is defined as the shortest one of distances between a point within a nodule candidate and each point on the boundary of the nodule candidate. As shown in FIG. 9, the deepness of a point within a nodule candidate 80 is the shortest one of distances between this point and each point on the boundary of the nodule candidate 80. In FIG. 9, the deepnesses of the points A, B, and C are the lengths of line segments corresponding to the points A, B, and C.

A point having the highest deepness of the points of a nodule candidate is set as a core point. In FIG. 9, the point A is a core point. The core point denotes a point which is three-dimensionally the deepest of the points of a nodule candidate. In FIG. 9, a nodule candidate is not spherical, so the centroid of the nodule candidate cannot be set as the center (i.e., the core point) of the nodule candidate. After the core point of the nodule candidate is determined, the distance from each of the points to the core point is calculated and stored as a radial distance. As shown in FIG. 11, the radial distribution function is calculated with the radial distance as an axis x and the number of voxels included in a nodule candidate as an axis y.

The radial distribution function of a nodule candidate having a shape of an ideal sphere can be expressed in a graph which increases up to the vertex, which is the maximum number of voxels in the axis y, along a secondary curve and thereafter drops to 0. However, it is rare that a nodule candidate has a shape of an ideal sphere. Hence, the radial distribution function of a nodule candidate is usually expressed in a graph which increases up to the vertex, which is the maximum number of voxels in the axis y, almost like a secondary curve and then gradually decreases to 0 instead of immediately dropping to 0, forming a tail portion. In both FIGS. 11 and 13, the tail portion denotes a collection of points which have radial distances of 7 or greater in the axis x. If the radial distribution function of a nodule candidate satisfies two conditions that the radial distribution function is close to a secondary curve fitting function up to the vertex and that the radial distribution function draws a rapid decrease after the vertex, the tail portion of the nodule candidate is cut off. The starting point of the tail portion of the radial distribution function can be defined by the radial distance where the radial distribution function drops to 30 to 70% of the vertex. In the present embodiment, the tail portion of the radial distribution function starts with the radial distance where the radial distribution function drops to 50% of the vertex. If the radial distribution function of a nodule candidate has a long tail portion after the vertex, the nodule candidate has a blood vessel. Hence, in step 764 of FIG. 7, a N-generation nodule candidate group is replaced by a core nodule candidate from which a tail portion has been removed by cutting off the voxels counted after the vertex is calculated. In step 765 of FIG. 7, the core nodule candidate undergoes a recursive analysis loop. If the recursive analysis loop for the core nodule candidate is completed, a tail nodule candidate, which is a collection of points included in the cut-off tail portion, is registered as a new N-generation nodule candidate. Then, the tail nodule candidate undergoes a recursive analysis loop. Accordingly, even a nodule candidate determined to be a non-nodule because of a blood vessel attached thereto can be properly analyzed. Also, since a separated tail portion is registered as a new nodule candidate and three-dimensionally analyzed, two nodules attached to each other or several nodules attached to a blood vessel are also separated from one anther so that a single nodule can be accurately analyzed.

The embodiment of the present invention can be written as computer programs, which can be provided by a computer readable recording medium. The recording medium can be operated by a microprocessor. Hence, as shown in FIG. 1, the recording medium is operated by the microprocessor 14 of the hardware system 1 so as to more easily perform the present invention. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

The recording medium stores a program including first through sixth program modules. In the first program module, a chest CT image is obtained. In the second program module, a lung region is extracted from the CT image. In the third program module, a nodule candidate group is extracted from the lung region using a gray-level thresholding technique and a 3-D region growing technique. In the fourth program module, a nodule candidate is separated into a core portion and a tail portion using NIRD. In the fifth program module, a rule-based system which analyses 3-D features of the nodule candidate to determine whether the nodule candidate is a pulmonary nodule is implemented. In the sixth program module, the third, fourth, and fifth program modules are recursively performed.

The fourth program module includes first through sixth program sub-modules. In the first program sub-module, the deepness of each of the points of the nodule candidate is calculated. In the second program sub-module, a point having the greatest deepness is set as a core point. In the third program sub-module, a radial distance of the points other than the core point, which is a distance between each of the points and the core point is calculated. In the fourth program sub-module, a radial distribution function having the radial distance as an axis x and the number of voxels as an axis y is obtained. In the fifth program sub-module, a portion starting from a radial distance where the graph of the radial distribution function drops from the vertex to 30 to 70% of the vertex is defined as a tail portion, a tail nodule candidate is defined by removing voxels corresponding to the tail portion from the voxels of the nodule candidate, and a remaining portion of the nodule candidate is defined as a core nodule candidate. In the sixth program sub-module, the sixth program module is re-performed on the core and tail nodule candidates.

Also, functional codes and code segments for accomplishing the program modules and sub-modules can be easily construed by programmers skilled in the art to which the present invention pertains.

The above-described analysis can be referred to as a 3-D recursive analysis (3DRA) technique, which is considered as an improved multi-gray-level thresholding technique. The use of an existing multi-gray-level thresholding technique is limited to an operation of extracting features from an extracted nodule candidate. However, the 3DRA technique has an improvement in that parameters extracted from a relationship between parent and child nodes in a tree structure of nodule candidates are utilized in a pulmonary nodule analysis operation. Also, the present invention proposes an NIRD technique of isolating a nodule from another nodule or a vessel attached to the nodule.

The present invention provides a method of automatically detecting pulmonary nodules from a lung region automatically extracted from a chest CT image, so automatically detected pulmonary nodules are referred in an early medical checkup for detecting an incipient lung cancer. In this method, a 3-D feature analysis is recursively applied to nodule candidates so that a blood vessel, a normal anatomical structure, and other pulmonary nodules are distinguished from one another. Thus, only pulmonary nodules can be accurately detected. A computer readable recording medium stores a program for executing the detection method. The use of the recording medium as a CAD program increases the accuracy of doctors' decisions.

The NIRD algorithm, which is a core feature of the present invention, is used to analyze the 3-D shape of a nodule, thereby increasing the reliability of analysis results. Since a parameter extracted from the relationship between nodule candidates that form a parent node and a child node is used in pulmonary nodule analysis, the number of false positive decisions is reduced, and a highly sensitive detection can be achieved.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of automatically detecting pulmonary nodules, the method comprising the operation of:
acquiring a chest computed tomography (CT) image;
extracting a lung region from the chest CT image;
extracting a group of nodule candidates from the lung region using a gray-level thresholding technique and a three-dimensional (3-D) region growing technique; and
recursively performing 3-D feature calculation and analysis on all of the nodule candidates,
wherein:
in every recursive analysis operation, each of the nodule candidates is divided into smaller nodule candidates using a nodule isolation technique based on a radial distribution function and a technique of re-extracting the nodule candidates so that the nodule candidates can establish a tree structure by increasing a gray level threshold,
the recursive analysis operation is repeated until each of the nodule candidates is determined to be one of a pulmonary nodule and a non-pulmonary-nodule or until a volume of the nodule candidate becomes too small to mean a nodule, and
a parameter extracted from a relationship between nodule candidates that form parent and child nodes in the tree structure is used as a 3-D feature.

2. The method of claim 1, wherein the lung region extraction operation comprises the sub-operations of:
binarizing the CT image using a gray-level thresholding technique;
labeling a lung region image and an air-filled region image in the binarized image using a connected component labeling technique;
removing the air-filled region image;
binarizing the lung region image;
extracting a contour of the binarized lung region image using an edge detection technique;
extracting only a lung contour from the contour of the binarized lung region image; and
correcting the lung contour.

3. The method of claim 2, wherein the lung contour correction sub-operation comprises:
setting a line segment which extends a length of d from each convex point existing on the lung contour such that the line segment is perpendicular to the lung contour;
lowering one end of the line segment clockwise or counterclockwise until the end meets another point on the lung contour, while the other end is being fixed at the convex point; and
setting as a new lung contour a line segment between the convex point and the point encountered with the convex point.

4. The method of claim 1, wherein the nodule candidate group extraction operation comprises:
setting a specific-generation gray level threshold to be used upon seed extraction;
if a voxel having the specific-generation gray level threshold or greater first appears during scanning of the lung region, setting the voxel as a seed point of a group of specific-generation nodule candidates; and
applying a 3-D region growing technique to the seed point.

5. The method of claim 1, wherein in the technique of re-extracting the nodule candidates so that the nodule candidates can establish a tree structure, a new nodule candidate is extracted by increasing the gray-level threshold by a 50 Hounsfield Unit (HU) each time.

6. The method of claim 1, wherein the nodule isolation technique comprises the operations of:
calculating a deepness of each of points included in the nodule candidate;
setting a point having the greatest deepness as a core point;
calculating a radial distance of each of the points, which is a distance between the point and the core point;
calculating a radial distribution function with the radial distance as an axis x and the number of points as an axis y;
defining as a tail portion a portion starting from the radial distance where the radial distribution function drops to 30 to 70% of a vertex, defining a tail nodule candidate by removing voxels corresponding to the tail portion from the nodule candidate, and defining as a core nodule candidate the nodule candidate from which the tail nodule candidate has been removed; and
replacing the nodule candidate with the core nodule candidate, re-performing recursive analysis on the core nodule candidate, and performing a new 3-D feature recursive analysis on the tail nodule candidate.

7. The method of claim 6, wherein a portion starting from a point where the radial distribution function drops from the vertex to 50% or less of the vertex is defined as the tail portion.

8. The method of claim 6, wherein the deepness calculating operation comprises:
extracting outermost points from the points included in the nodule candidate;
calculating a distance between a point whose deepness is, to be calculated and each of the outermost points; and
setting the smallest distance of the calculated distances as the deepness of the point.

9. The method of claim 1, wherein the parameter is a volume ratio obtained by dividing a volume of a child node candidate by a volume of a parent node candidate.

10. The method of claim 9, wherein, if the volume ratio is no more than 0.02, the child node candidate is determined to be a non-nodule.

11. A computer readable recording medium which stores a program, the program comprising:
a first program module obtaining a chest CT image;
a second program module extracting a lung region from the CT image;
a third program module extracting a nodule candidate group from the lung region using a gray-level thresholding technique and a 3-D region growing technique;
a fourth program module separating a nodule candidate into a core portion and a tail portion using a nodule isolation technique based on a radial distribution function;
a fifth program module implementing a rule-based system which analyses 3-D features of the nodule candidate to determine whether the nodule candidate is a pulmonary nodule; and
a sixth program module recursively performing the third, fourth, and fifth program modules.

12. The computer readable recording medium of claim 11, herein the fourth program module comprises:
a first program sub-module calculating a deepness of each of the points included in the nodule candidate;
a second program sub-module setting a point having the greatest deepness as a core point;
a third program sub-module calculating a radial distance of each of the points other than the core point, which is a distance between the corresponding point and the core point;
a fourth program sub-module obtaining a radial distribution function having the radial distance as an axis x and the number of points as an axis y;
a fifth program sub-module defining as a tail portion a portion starting from a radial distance where the radial distribution function drops from a vertex to 30 to 70% of the vertex, defining a tail nodule candidate by removing voxels corresponding to the tail portion from all of the voxels included in the nodule candidate, and defining a remaining portion of the nodule candidate as a core nodule candidate; and
a sixth program sub-module re-performing the sixth program module on the core and tail nodule candidates.
